(19) United States
(12) Patent Application Publication
(10) Pub. No.: US 2008/0205724 A1
(43) Pub. Date: Aug. 28, 2008

(54) Method, an Apparatus and a Computer Program For Segmenting an Anatomic Structure in a Multi-Dimensional Dataset

(75) Inventors: Christian Adrian Cocosco, Hamburg (DE); Wiro Joep Niessen, Rotterdam (NL); Thomas Netsch, Eindhoven (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 11/911,216

(22) PCT Filed: Apr. 11, 2006
(86) PCT No.: PCT/IB06/51112

§ 371 Date: Oct. 11, 2007

(30) Foreign Application Priority Data
Apr. 12, 2005 (EP) 05102864.5

(51) Int. Cl. G06K 9/00

(52) U.S. Cl. 382/130

(57) ABSTRACT

The method 1 according to the invention is preferably practiced in real time and directly after a suitable acquisition 3 of the multi-dimensional dataset, which is accessed at step 5 and the images constituting the multi-dimensional dataset are classified at step 8. Preferably, for reducing an amount of data to be processed at step 6 the image data is subjected to a restrictive region of interest determination. At step 9 the classified cardiac images are subjected to a an image thinning operator so that the resulting images comprise a plurality of connected image components which are further analyzed at step 14. After the thinning step 9 a labeling step 11 is performed, where different connected components in the multi-dimensional dataset are accordingly labeled. This step is preferably followed by a region growing step 13, which is constrained by binary threshold used at step 8b. For each connected image component a factor F is computed at step 14. The anatomic structure is segmented at step 16 by selecting the connected image component with factor F meeting a pre-determined criterion. After this, the segmented anatomic structure is stored in a suitable format at step 18. The invention further relates to an apparatus, a working station, a viewing station and a computer program.

The invention relates to a method for segmenting an anatomic structure in a multi-dimensional dataset comprising a plurality of temporally spaced cardiac images comprising data on a target matter and on an other matter.

The invention further relates to an apparatus for segmenting an anatomic structure in a multi-dimensional dataset comprising a plurality of temporally spaced cardiac images comprising data on a target matter and on an other matter.

The invention still further relates to a computer program for segmenting an anatomic structure in a multi-dimensional dataset comprising a plurality of temporally spaced cardiac images comprising data on a target matter and on an other matter.

An embodiment of the method as is set forth in the opening paragraph is known from U.S. Pat. No. 5,903,664. The known method is arranged to carry out an image segmentation step for purposes of identifying contiguous regions of the same target matter from suitable diagnostic images. In particular the known method is suited for segmenting the left ventricle from suitable diagnostic cardiac images. For this purpose in the known method a suitable region of interest in the cardiac images is determined under an operator supervision whereby an initial seed point within the envisaged region of interest is located. Also, an initial threshold for pixel or voxel classification is identified. Starting with a suitable initial image selected from the multi-dimensional dataset comprising temporally spaced cardiac images, points of the image within the region of interest are classified. Contiguous image elements having the same classification as the seed point and being connected to the seed point through image points all having the same classification are identified thus defining the thought segmented structure in the image.

It is a disadvantage of the known method that for enabling a segmentation of the thought anatomic structure, notably a ventricle in the heart an interaction with an operator is necessary whereby a threshold used for classification is defined. This results in a poor robustness of the known method with respect to both a user reproducibility and a segmentation accuracy. The former problem is explained by the fact that for the same multi-dimensional dataset different operators may select different thresholds. The latter problem is explained by the fact that an intensity of picture elements or volume elements representing fat in cardiac images is similar to those of blood leading in a poor differentiation between the ventricular tissue and fat tissue. This leads to inferior segmentation results.

It is an object of the invention to provide a method for segmenting an anatomic structure in a multi-dimensional dataset comprising a plurality of temporally spaced cardiac images comprising data on a target matter and on an other matter, whereby said method provides more accurate segmentation of the anatomic structure, notably a ventricle of the heart.

To this end the method according to the invention comprises the following steps:

performing a classification of cardiac images to distinguish between the target matter and the other matter yielding classified cardiac images comprising the target matter;

applying a thinning operator to the classified cardiac images yielding processed cardiac images comprising connected image components;

labeling different connected image components yielding respective labeled connected image components;

for each labeled connected image component compute a factor based on its volume variability with time;

segmenting the anatomic structure by selecting the connected image component with the factor meeting a pre-determined criterion.

The technical measure of the invention is based on the following insights:

i) the heart's ventricles exhibit coherence along all dimensions of a notably four-dimensional dataset. Specifically, within a cross-sectional slice space the core of the ventricle is substantially static for slices acquired for different longitudinal positions and for different temporal phases;
ii) the ventricles contract and expand significantly during the cardiac cycle, unlike the fat tissue.

Thus, based on these observation, the ventricles can be automatically distinguished among bright regions in the, for example, four-dimensional dataset, whereby regions are defined as connected clusters of bright pixels or voxels. For this purpose use can be made of per se known image processing techniques.

Therefore, in the first step of the method according to the invention performing a classification of cardiac images to distinguish between the target matter, notably blood and the other matter, notably non-blood is performed yielding classified cardiac images comprising substantially the target matter. This step can be enabled by using an automatic unsupervised binary voxel classification by computing the intensity histogram of the entire three-dimensional and temporal image. After this, a binary shareholding method is applied. An example of a suitable binary thresholding method is given in N. Otsu “A threshold selection method for gray-level histograms”, IEEE Transactions on System Man and Cybernetics, smc-9(1): 62-66. January, 1979. After the classified cardiac images are obtained, a suitable thinning operator is applied to the classified cardiac images yielding processed cardiac images comprising connected image components. The thinning operator is applied for the cross-sectional images, for example by utilizing “E”-morphological erosion steps with an 8-connected two-dimensional kernel, where E is preferably set to a value of 6.25 mm/voxel-X-size. Next, the step of labeling of connected image components is performed, whereby connectivity is determined using an 8-connected 4D kernel. Next, for each labeled connected image component a factor is computed, which is preferably based on a difference between a first volume of the connected image component and a second volume of the connected image component among all temporal phases of the cardiac images. Preferably, the first volume is set to a second largest volume and the second volume is set to a second smallest volume to ensure robust estimation of the volume variation in time. Finally, the anatomic structure is segmented by selecting the connected image component with the factor meeting a pre-determined criterion. Preferably, the pre-determined criterion is set as the largest value of said difference.

In an embodiment of the method according to the invention, the method further comprises a preparatory step of automatically computing a restrictive region of interest around the heart in the cardiac images of the multi-dimensional dataset. This technical measure ensures a substantial reduction of image information for segmentation purposes as parts of the image not belonging to the region of interest are neglected. Preferably, a method disclosed in C. A. Cocosco et al “Automatic cardiac region-of interest computation in cine 3D structural MRI”, Computer Assisted Radiology and Surgery (CARS), 2004 is used.

In a further embodiment of the method according to the invention, the method further comprises the steps of:

performing a region growing operation for the multi-dimensional dataset, whereby said region growing operation is being constrained by a parameter deduced from the classified cardiac images.

Preferably, this step is carried out using opening by reconstruction, for example implemented using morphological dilation with a 4-connected 2D-kernel in the cross-sectional slice plane as well as “D2”-dilation steps in the longitudinal direction using a 2-connected 1D-kernel, whereby the factor D2 is preferably set to 16 mm/voxel-Z-size.

In a still further embodiment of the method according to the invention, the method further comprises the following steps:

applying a thinning operator to the classified cardiac images yielding processed cardiac images comprising further connected image components;

labeling different further connected image components yielding respective labeled further connected image components;

for each labeled further connected image component compute a factor based on its volume variability in time;

segmenting the further anatomic structure by selecting the further connected image component with the value of said further factor meeting a further pre-determined criterion.

The resulting segmentation will advantageously comprise accurately segmented two anatomic structures, notably the left cardiac ventricle and the right cardiac ventricle.

In a still further embodiment of the method according to the invention the method still further comprises the step of segmenting a still further anatomic structure based on a comparison between the segmented anatomic structure and the segmented further anatomic structure.

This technical measure is based on the insight that the cardiac muscle surrounds the left ventricle and is partially bounded by the right ventricle. Thus, provided the left ventricle and the right ventricle are accurately segmented whereby fat tissue is robustly eliminated during the segmentation steps, the segmentation of the two ventricles provide a substantial segmentation of the cardiac muscle. The segmentation of the cardiac muscle is important for clinical studies aimed at wall thickness and motion analysis.

In a still further embodiment of the method according to the invention, the method further comprises the steps of:

computing a still further factor based on a relationship between the factor and the further factor;

comparing a value of the still further factor with a still further pre-determined criterion;

performing an automatic correction of a stack of cardiac images upon an event that the still further factor and the criterion inter-relate in a pre-determined way.

This technical measure is based on a further insight that due to imprecise scan planning or due to substantial axial heart motion, the basal short-axis transversal slice extends into the atria which may decrease the accuracy of ventricular segmentation. Further on, it is empirically determined that there is a reproducible indicator of such an event. Notably, when for the still further factor a ratio of the two largest values of the factor described above is selected, the criterion can be set to a simple numerical value. For example when the still further factor is given by F1/F2, whereby F1 is the largest value of the difference between a first volume of the connected image component and a second volume of the connected image component among all temporal phases of the cardiac images for the left ventricle and F2 is the same for the right ventricle, a correction of the stack of images is required when the ratio F1/F2 is greater than 4,0. The correction can be enabled by cropping the top Z slice in the four-dimensional image obtained after the thinning operator is applied to the classified image, then by repeating the labeling step, then growing the labeled components back into the top Z slice, preferably using an opening by reconstruction morphological operation. Concluding, the steps of region growing and segmenting are performed. This technical measure is particularly advantageous as it provides a fully automated means for image stack error detection and correction enabling a fully automated accurate and robust image segmentation method.

In a still further embodiment of the method according to the invention, the method further comprises the step of:

visualizing the at least any one of the segmented anatomic structure, the segmented further anatomic structure and the segmented still further anatomic on a display means.

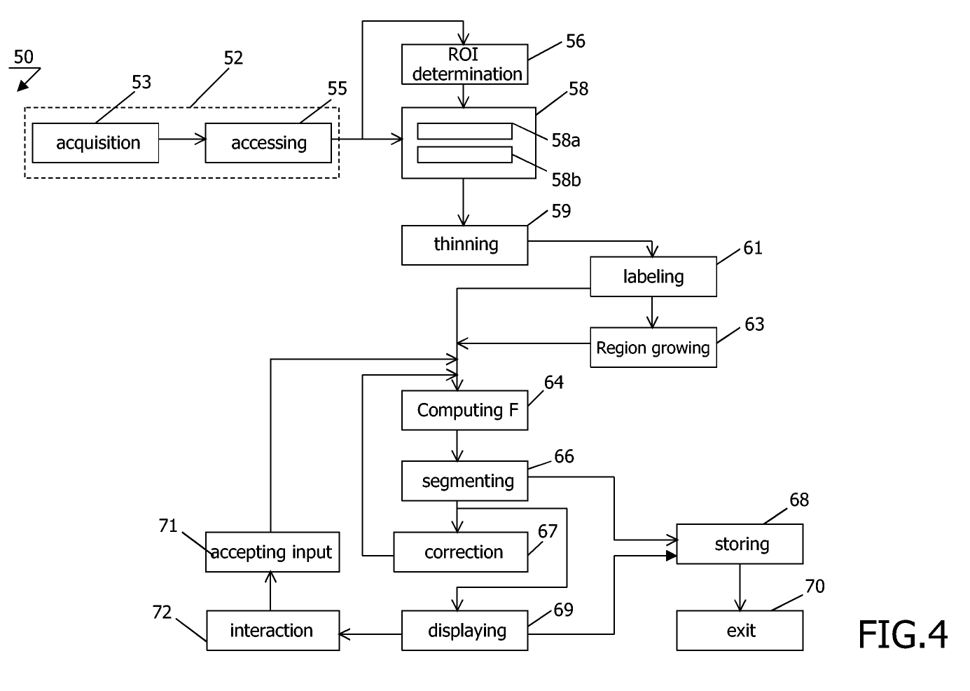

It is considered to be advantageous to enable an investigation of the segmentation results by a user. An experienced user may detect minor segmentation failures, particularly when the image stack is erroneously prepared allowing an extension of the short-axis transversal slice into the atria. To correct for this, the user may manually mark a boundary between the left ventricle and the right ventricle, which can be enable by a convenient computer mouse action. In fact, in the usual situation where only the ejection fraction measurement is needed, it is sufficient to mark the boundary on two two-dimensional slices, one for end-diastole and one for end systole temporal phases. This feature will be explained in more detail with reference to FIG. 4.

An apparatus according to the invention comprises:

an input for accessing the multi-dimensional dataset;

a computing means for:

i. performing a classification of cardiac images to distinguish between the target matter and the other matter yielding classified cardiac images comprising the target matter;
ii. applying a thinning operator to the classified cardiac images yielding processed cardiac images comprising connected image components;
iii. labeling different connected image components yielding respective labeled connected image components
iv. computing for each labeled connected image component a factor based on a its volume variability with time;
v. segmenting the anatomic structure by selecting the connected image component with the factor meeting a pre-determined criterion.

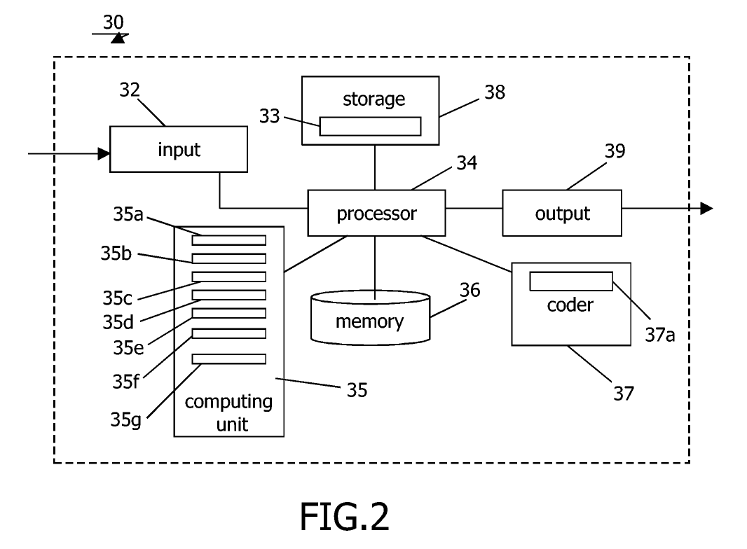

It is possible that the apparatus according to the invention is arranged as a working station, which may be arranged as a stand-alone device or may be connectable to a remote unit by means of suitable remote access facilities, like internet. Preferably, the apparatus according to the invention is further arranged with a suitable display unit for displaying the segmented anatomic structure. Advantageously, such configuration may be arranged as a viewing station, which is used for inspection of the segmentation results. Preferably, the apparatus according to the invention is further arranged with a suitable data acquisition unit for acquiring the multi-dimensional dataset. Preferred embodiments of the suitable data acquisition unit comprise a magnetic resonance imaging apparatus, a computer tomography unit, an X_ray device and an ultra-sonic probe. A preferable data acquisition mode for the magnetic resonance imaging unit is “balanced Fast Field Echo”, (bFFE). Further advantageous embodiment of the apparatus according to the invention will be discussed with reference to FIG. 2.

A computer program according to the invention comprises instructions for causing the processor to carry out the steps of:

performing a classification of cardiac images to distinguish between the target matter and the other matter yielding classified cardiac images comprising the target matter;

applying a thinning operator to the classified cardiac images yielding processed cardiac images comprising connected image components;

labeling different connected image components yielding respective labeled connected image components;

for each labeled connected image component compute a factor based on its volume variability in time;

segmenting the anatomic structure by selecting the connected image component with the factor meeting a pre-determined criterion.

Preferably, the computer program according to the invention comprises a further instructions to cause the processor to carry out a further step of: automatically computing a restrictive region of interest around the heart in the cardiac images of the multi-dimensional dataset and/or a still further step of:

performing a region growing operation for a transversal slice plane, whereby said region growing operation is being constrained by a parameter deduced from the classified cardiac images.

Still preferably, the computer program according to the invention still further comprises instructions for causing the processor to carry out still further steps as are set forth with reference to claims 4, 5, 6, 7.

These and other aspects of the invention will be explained in further details with reference to figures.

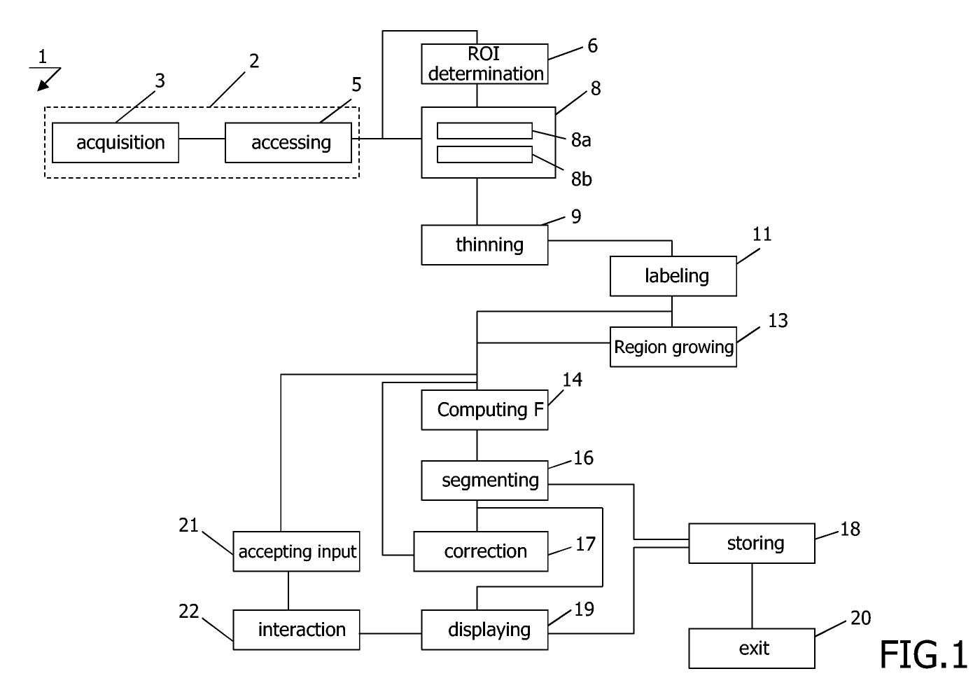

FIG. 1 presents a schematic view of an embodiment of the method according to the invention.

FIG. 2 presents a schematic view of an embodiment of the apparatus according to the invention.

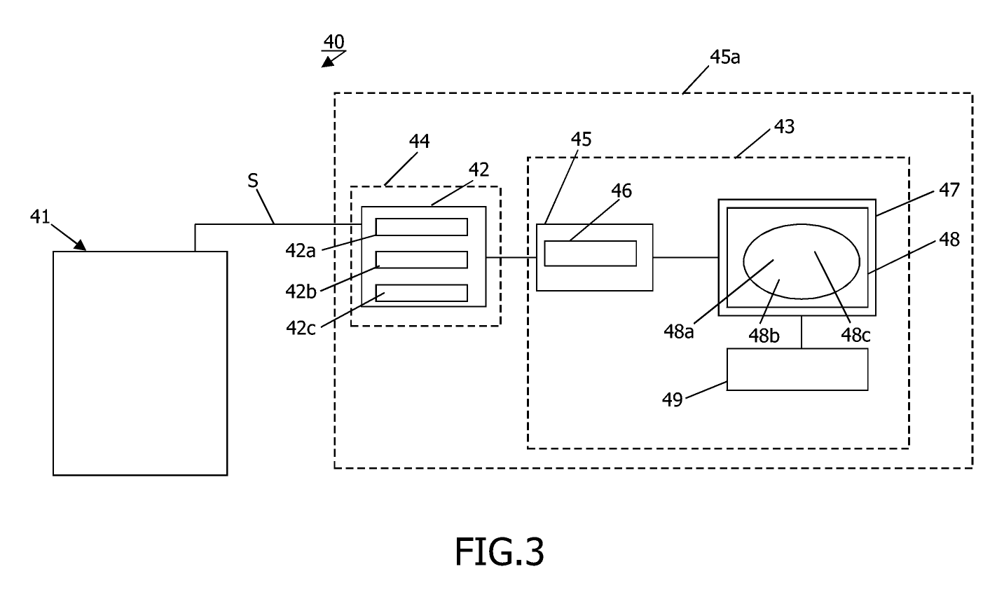

FIG. 3 presents a schematic view of a further embodiment of the apparatus according to the invention.

FIG. 4 presents a schematic view of an embodiment of a flow-chart of the computer program according to the invention.

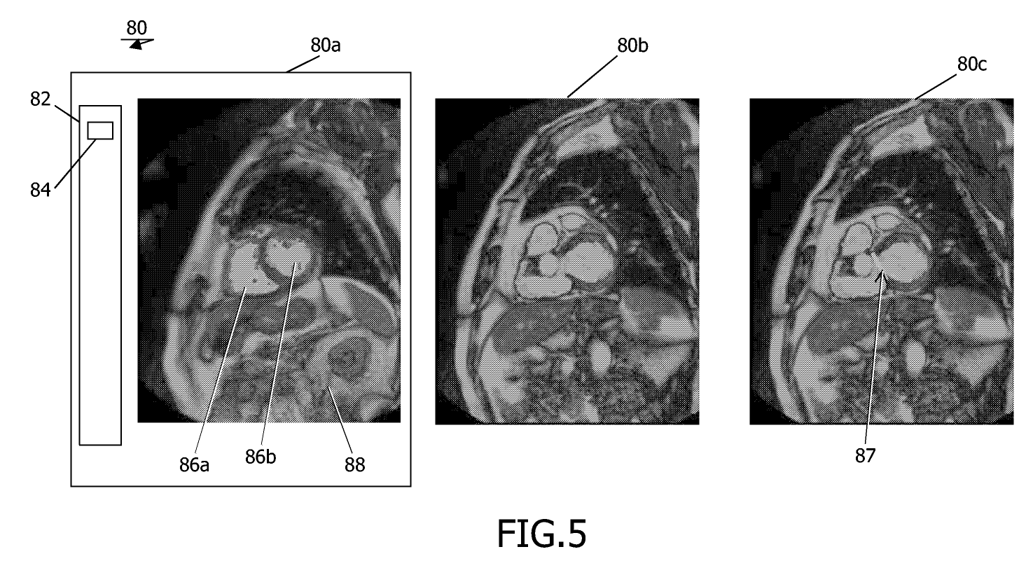

FIG. 5 presents a schematic view of an embodiment of a display view allowing a user to correct for an erroneous image stack.

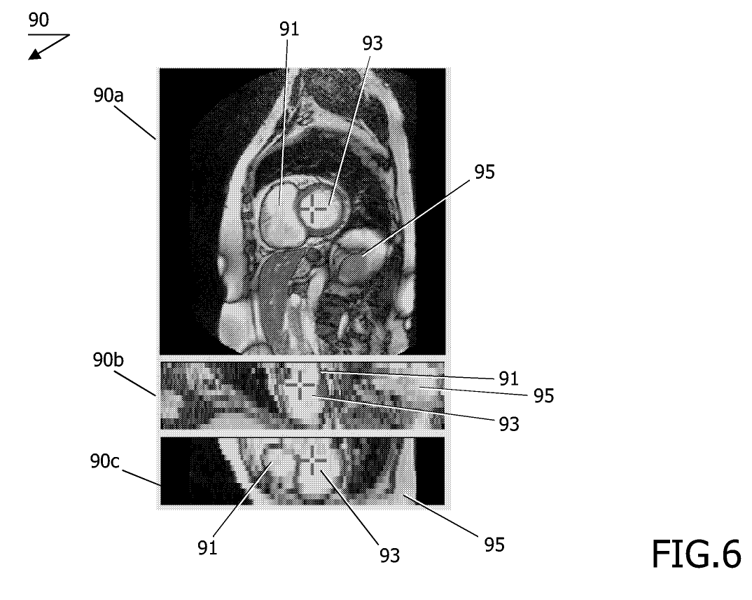

FIG. 6 presents a schematic view of an embodiment of a display whereby results of segmentation step are presented.

FIG. 1 presents a schematic view of an embodiment of the method according to the invention. The method 1 of the invention is particularly suited for segmenting cardiac structures from multi-dimensional dataset comprising suitable plurality of temporally spaced cardiac images. Preferably, the method 1 is practiced in real time and directly after a suitable acquisition 3 of the multi-dimensional dataset. Preferably, the acquisition is performed using a magnetic resonance imaging apparatus operable in the balanced Fast Field Echo (bFFE) data acquisition mode. The acquired multi-dimensional dataset is then accessed at step 5 thus finalizing the preparatory step 2 after which it is processed for purposes of segmenting the thought cardiac structure. It is noted that it is possible to practice the method of the invention when the step 5 is conceived to access a pre-stored data, locally or by means of a remote access, notably by means of internet or like technologies. Upon an event the multi-dimensional dataset is accessed the images constituting the multi-dimensional dataset are classified at step 8, whereby at step 8a, for example, an intensity histogram is computed for all dimensions of the multi-dimensional dataset, it being preferably three-dimensional data and temporal information. After this, at step 8b a suitable binary thresholding algorithm is applied, for example in accordance with N. Otsu “A threshold selection method for gray-level histograms”, IEEE Transactions on System Man and Cybernetics, smc-9(1): 62-66. January, 1979.

Preferably, for reducing an amount of data to be processed at step 6 the image data is subjected to a restrictive region of interest determination, whereby substantially the cardiac tissue is left in the image, the background or other tissue information being suppressed or eliminated. Preferably, the method of automatic region of interest determination is carried out in accordance with C. A. Cocosco et al “Automatic cardiac region-of interest computation in cine 3D structural MRI”, Computer Assisted Radiology and Surgery (CARS), 2004.

At step 9 the classified cardiac images are selected in the transversal plane and subjected to a per se known image thinning operator, preferably by means of utilizing “E”-morphological erosion steps with an 8-connected two-dimensional kernel, where E is preferably set to a value of 6.25 mm/voxel-X-size. The resulting images comprise a plurality of connected image components which are further analyzed at step 14. It is noted that after the thinning step 9 a labeling step 11 is required, where different connected components in the multi-dimensional dataset are accordingly labeled. This step is preferably followed by a region growing step 13, which is constrained by binary threshold used at step 8b.

Next, for each connected image component a factor F is computed at step 14, which is based on a difference between a first volume of the connected image component and a second volume of the connected image component among all temporal phases of the cardiac images. Preferably, the first volume is set to a second largest volume and the second volume is set to a second smallest volume to ensure robust estimation of these volumes. Finally, the sought anatomic structure is segmented at step 16 by selecting the connected image component with the factor F meeting a pre-determined criterion. Preferably, the pre-determined criterion is set as the largest value of said difference. After this, the segmented anatomic structure, notably a ventricle, is stored in a suitable format at step 18.

The method 1 according to the invention may comprise additional advantageous steps to further increase the robustness of the segmentation result. Notably, for cases when the domain of cardiac image is inferiorly prepared, allowing the basal short-axis transversal slice to extend into the atria, the segmentation method according to the invention may experience some difficulties when separating left ventricle from the right ventricle. In order to eliminate this problem, in the method 1 according to the invention an automatic image domain correction step 17 is envisaged. This technical measure is based on an empirically determined fact that there is a reproducible indicator of such event. Notably, when for this indicator a ratio of the two largest respective values of the F-factor per ventricle is selected, the criterion can be set to a simple numerical value. For example when the ratio is given by F1/F2, whereby F1 is the largest value of the difference between a first volume of the connected image component and a second volume of the connected image component among all temporal phases of the cardiac images for the left ventricle and F2 is the same for the right ventricle, a correction of the stack of images is required when the ratio F1/F2 is greater than 4,0. The correction can be enabled by cropping the top Z slice in the four-dimensional image obtained after the thinning operator is applied to the classified image, then by repeating labeling step, then growing the labeled components back into the top Z slice, preferably using an opening by reconstruction morphological operation. Concluding, the steps of region growing and segmenting are performed. This technical measure is particularly advantageous as it provides a fully automated means for image stack error detection and correction enabling a fully automated accurate and robust image segmentation method.

In an alternative embodiment, after the segmentation step 16, the method proceeds to the step 19, whereby the segmentation results are displayed to the user on a suitable display means. Preferably the display mode comprises an overlay, notably in color, of the segmented anatomic structure on the cardiac images. In case the operator is satisfied with the results, the method stops at step 20. Alternatively, the operator indicates a boundary between the left ventricle and the right ventricle at step 22, after which this user-input is accepted at step 21 by a suitable per se known graphic user interface, after which the method returns to steps 14 and 16, which is carried out using a new geometric constrain, namely the boundary between the left and the right ventricle. It is noted that it is sufficient to mark said boundary only on two transversal sliced, one for an end-systole phase and one for the end-diastole phase. When the new segmentation is shown to the user at step 19 and the user is satisfied with the result, the method stops at step 20.

FIG. 2 presents a schematic view of an embodiment of the apparatus according to the invention. The apparatus 30 comprises an input 32 for accessing the multi-dimensional dataset comprising a plurality of temporally spaced cardiac images. The multi-dimensional dataset may be accessed from a suitable storage unit (not shown), which may be situated locally or remotely. Alternatively and/or additionally the input 32 can be arranged to receive data from a suitable data acquisition unit providing the multi-dimensional dataset. The multi-dimensional dataset is then made available by the input 32 to a computing unit 35 of the apparatus 30, which is arranged to carry out the image segmentation in accordance with the invention yielding thought anatomic structure, notably the two cardiac ventricles. These steps are implemented using per se known respective computing algorithms, which are explained in the foregoing.

The core of the apparatus 30 is formed by a processor 34 which is arranged to operate the components of the apparatus 30, it being the input 32, the computing unit 35, the working memory 36, and the background storage unit 38. An example of a suitable processor 34 is a conventional microprocessor or signal processor, the background storage 38 (typically based on a hard disk) and working memory 36 (typically based on RAM). The background storage 38 can be used for storing suitable datasets (or parts of it) when not being processed, and for storing results of the image segmentation step, the step of determining respective volumes and F-factors, suitable criteria and thresholds as well as results of any other suitable intermediate or final computational steps. The working memory 36 typically holds the (parts of) dataset being processed and the results of the segmentation of the anatomic structure. The computing unit 35 preferably comprises a suitable number of executable subroutines 35a, 35b, 35c, 35d, 35e and 35f. The subroutine 35a is arranged to perform a classification of cardiac images to distinguish between the target matter, notably blood, and the other matter, notably fat tissue yielding classified cardiac images. The subroutine 35b is arranged to apply a thinning operator to the classified cardiac images yielding processed cardiac images comprising respective connected image components. The subroutine 35c is arranged to compute for each connected image component an F-factor based on a difference between a largest volume of the connected image component and the smallest volume of the connected image component. The subroutine 35d is arranged to perform suitable labeling of the connected image components. The subroutine 35e is arranged to segment the anatomic structure by selecting the connected image component with a maximum value of the F-factor.

Preferably, the computing unit 35 further comprises a subroutine 35f, arranged to compute a still further factor F′, based on a ratio between the respective F-factors for different anatomic structures, notably the left ventricle and the right ventricle. In case the F′ factor relates to a pre-determined criterion in a pre-determined way, this fact is signaled to the processor 34 as an event of the structure segmentation with reduced accuracy. In this case the processor 34 proceeds to a still further subroutine 35g, which is arranged to perform an automatic correction of the stack of cardiac images in accordance with the method of the invention discussed above.

The apparatus 30 according to the invention further comprises an overlay coder 37 arranged to produce a rendering of a suitable overlay of the original data with the results of the segmentation step. Preferably, the computed overlay is stored in a file 37a. Preferably, overlay coder 37, the computing unit 35 and the processor 34 are operable by a computer program 33, preferably stored in memory 38. An output 39 is used for outputting the results of the processing, like overlaid mage data representing the anatomy of the heart overlaid with the suitable rendering of the segmented structure. Further details are presented with reference to FIG. 5 and FIG. 6.

FIG. 3 presents a schematic view of a further embodiment of the apparatus according to the invention. The apparatus 40 is arranged for segmenting an anatomic structure in a multi-dimensional dataset comprising a plurality of temporally spaced cardiac images. Preferably, the apparatus 40 comprises a data acquisition unit 41, notably a magnetic resonance imager, a tomography unit, an ultra-sound apparatus, or an X-ray unit for acquiring the multi-dimensional dataset. Usually the data is conceived to be transferred from the data acquisition unit 41 to the processor 42 by means of a suitably coded signal S. The processor performs suitable data segmentation, as is explained with reference to FIG. 2, whereby at its output a variety of possible data can be produced. For example, it is possible that data 42a comprises segmentation of the left ventricle, the data 42b provides segmentation of the right ventricle and data 42c provides segmentation of the myocardium, which is deduced from the data 42a and 42b. Preferably, the apparatus 40 is embedded in a workstation 44, which may be located remotely from the data acquisition unit 41.

Either of the data 42a, 42b, 42c or a suitable combination thereof is made available to a further input 45 of a suitable viewer 43. Preferably, the further input 45 comprises a suitable further processor arranged to operate a suitable interface using a program 46 adapted to control a user interface 48 so that an image of the anatomic data is suitably overlaid with the results of the segmentation step, notably with data 42a, 42b and/or 42c, thus yielding image portions 48a, 48b, 48c. Preferably, for user's convenience, the viewer 43 is provided with a high-resolution display means 47, the user interface being operable by means of a suitable interactive means 49, for example a mouse, a keyboard or any other suitable user's input device. Preferably, the user interface allows the user to interact with the image for purposes of marking a boundary between the left ventricle and the right ventricle, if necessary. Suitable graphic user input is translated into a geometric threshold by the computer program 46. This threshold is then provided to a computing means of the apparatus for a further iteration of the image segmentation step. This option allows for an accurate segmentation of the cardiac ventricles even in situations where the domain of input cardiac images is inferiorly prepared. Preferably, the apparatus 40 and the viewer 43 are arranged to form a viewing station 45a.

FIG. 4 presents a schematic view of an embodiment of a flow-chart of the computer program 50 according to the invention. The computer program 50 of the invention is particularly suited for segmenting cardiac structures from multi-dimensional dataset comprising suitable plurality of temporally spaced cardiac images. Preferably, the computer program 50 is practiced in real time and directly after a suitable acquisition 53 of the multi-dimensional dataset. Preferably, the acquisition is performed using a magnetic resonance imaging apparatus operable in the balanced Fast Field Echo (bFFE) data acquisition mode. The acquired multi-dimensional dataset is then accessed at step 55 thus finalizing the preparatory step 52 after which the dataset is conceived to be processed by the computer program for purposes of segmenting the thought cardiac structure. It is noted that it is possible to practice the method of the invention when the step 55 is conceived to access a pre-stored data, locally or by means of a remote access, notably by means of internet or like technologies. Upon an event the multi-dimensional dataset is accessed, the images constituting the multi-dimensional dataset are classified at step 58 by means of suitable computing algorithms. For example, at step 58a, an intensity histogram can be computed for all dimensions of the multi-dimensional dataset, it being preferably three-dimensional data and temporal information. After this, at step 58b a suitable binary thresholding algorithm is applied, for example in accordance with N. Otsu “A threshold selection method for gray-level histograms”, IEEE Transactions on System Man and Cybernetics, smc-9(1): 62-66. January, 1979.

Preferably, for reducing an amount of data to be processed at step 56 the image data is subjected to a restrictive region of interest determination using a suitable computing algorithm, whereby substantially the cardiac tissue is left in the image, the background or other tissue information being suppressed or eliminated. Preferably, the method of automatic region of interest determination is carried out in accordance with C.A. Cocosco et al “Automatic cardiac region-of interest computation in cine 3D structural MRI”, Computer Assisted Radiology and Surgery (CARS), 2004.

At step 59 the classified cardiac images are selected in the transversal plane and subjected to a per se known image thinning operator, preferably by means of utilizing “E”-morphological erosion steps with an 8-connected two-dimensional kernel, where E is preferably set to a value of 6.25 mm/voxel-X-size. The resulting images comprise a plurality of connected image components which are further analyzed at step 64. It is noted that after the thinning step 59 a labeling step 61 is required, where different connected components in the multi-dimensional dataset are accordingly labeled using respecting computing routines. This step is preferably followed by a region growing algorithm at step 63, which is constrained by binary threshold used at step 58b.

Next, for each connected image component a factor F is computed at step 64, which is based on a difference between a first volume of the connected image component and a second volume of the connected image component among all temporal phases of the cardiac images. Preferably, the first volume is set to a second largest volume and the second volume is set to a second smallest volume to ensure robust estimation of these volumes. Finally, the thought anatomic structure is segmented at step 66 by selecting the connected image component with the factor F meeting a pre-determined criterion. Preferably, the pre-determined criterion is set as the largest value of said difference. After this, the segmented anatomic structure, notably a ventricle, is stored in a suitable format at step 68.

The computer program 50 according to the invention may comprise additional advantageous steps to further increase the robustness of the segmentation result. Notably, for cases when the domain of cardiac image is inferiorly prepared, allowing the basal short-axis transversal slice to extend into the atria, the segmentation method according to the invention may experience some difficulties when separating left ventricle from the right ventricle. In order to eliminate this problem, in the computer program 50 according to the invention an automatic image domain correction step 67 is envisaged. This technical measure is based on an empirically determined fact that there is a reproducible indicator of such event. Notably, when for this indicator a ratio of the two largest respective values of the F-factor per ventricle is selected, the criterion can be set to a simple numerical value. For example when the ratio is given by F1/F2, whereby F1 is the largest value of the difference between a first volume of the connected image component and a second volume of the connected image component among all temporal phases of the cardiac images for the left ventricle and F2 is the same for the right ventricle, a correction of the stack of images is required when the ratio F1/F2 is greater than 4,0. The correction can be enabled by cropping the top Z slice in the four-dimensional image obtained after the thinning operator is applied to the classified image, then by repeating labeling step, then growing the labeled components back into the top Z slice, preferably using an opening by reconstruction morphological operation. Concluding, the steps of region growing and segmenting are performed. This technical measure is particularly advantageous as it provides a fully automated means for image stack error detection and correction enabling a fully automated accurate and robust image segmentation method.

In an alternative embodiment, after the segmentation step 66, the method proceeds to the step 69, whereby the segmentation results are displayed to the user on a suitable display means using suitable graphic user interface routines. Preferably the display mode comprises an overlay, notably in color, of the segmented anatomic structure on the cardiac images. In case the operator is satisfied with the results, the computer program stops at step 70. Alternatively, the operator indicates a boundary between the left ventricle and the right ventricle at step 72, after which this user-input is accepted at step 71 by a suitable per se known graphic user interface subroutine, after which the computer program returns to the step of segmenting 74, which is carried out using a new geometric constrain, namely the boundary between the left and the right ventricle. It is noted that it is sufficient to mark said boundary only on two transversal sliced, one for an end-systole phase and one for the end-diastole phase. When the new segmentation is shown to the user at step 69 and the user is satisfied with the result, the computer program stops at step 70.

FIG. 5 presents a schematic view of an embodiment of a display view allowing a user to correct for an erroneous image stack. Preferably such a display view is embedded in a suitable graphic user interface 80 allowing for interactive image handling. The present example shows three steps 80a, 80b and 80c allowing the user to correct for an erroneous image stack which have led to an incorrect segmentation of the sought anatomic structure, notably a cardiac ventricle. For clarity reasons only the first step 80a are shown with reference to a suitable graphic user interface window showing interactive buttons. Naturally, further steps 80b and 80c are carried out using the same graphic user interface. The graphic user interface is arranged to visualize the segmented anatomic structure, 86a, 86b, preferably overlaid as a suitable color-code on the original data 88, notably the diagnostic data. The graphic user interface further comprises a dedicated window 82 whereto a variety of alpha-numerical information can be projected. Additionally, the dedicated window 88 comprises a suitable plurality of interactive buttons 84 (for clarity reasons only one interactive button is shown). When any of the interactive buttons 84 is actuated, the graphic user interface carries out a corresponding pre-defined operation. The example of FIG. 5 shown a situation where due to the erroneous image stack the right ventricle is not separated from the left ventricle during the segmentation step. This is seen by the user when the right ventricle and the left ventricle are overlaid using the same coding, notable the same color code. When this event is noticed by the user, he proceeds to step 80b of the correcting procedure. For this, the user selects the basal slices for end-diastole and end-systole. This procedure may be preformed manually, or may be automated and prescribed to a certain pre-defined actuatable button of the type 84. When the basal slices are found and are projected to the user, he draws at step 80c an approximate line 87, which defines a spatial boundary between the left ventricle and the atria. The graphic user interface accepts the coordinates of the line 87 and reverses to the image segmentation step. The correction can be enabled by cropping the top Z slice in the four-dimensional image obtained after the thinning operator is applied to the classified image, then by repeating the labeling step, then growing the labeled components back into the top Z slice, preferably using an opening by reconstruction morphological operation. Concluding, the steps of region growing and segmenting are performed. This technical measure is particularly advantageous as it provides means for image stack error detection and correction enabling an accurate and robust image segmentation method.

FIG. 6 presents a schematic view of an embodiment of a display 90 whereby results of segmentation step are presented. Preferably, the segmentation results are displayed using a suitable graphic user interface allowing for interaction with the user. Still preferably, the graphic user interface is arranged to display the segmentation results using an orthogonal image representation. For example, the graphic user interface may comprise a window 90a for presenting a saggital cross-section, a window 90b for presenting a coronal cross-section, and a window 90c for presenting a transversal cross-section. Each window 90a, 90b, 90c presents an overlay of the anatomic data 95 with the rendered view of the segmented anatomical structures, for example the right cardiac ventricle 91 and the left cardiac ventricle 93. Preferably, the segmented anatomic structures 91, 93 are shown using a suitable color-code.

1. A method for segmenting an anatomic structure in a multi-dimensional dataset comprising a plurality of temporally spaced cardiac images comprising data on a target matter and on an other matter, said method comprising the following steps:
performing a classification of cardiac images to distinguish between the target matter and the other matter yielding classified cardiac images comprising the target matter;
applying a thinning operator to the classified cardiac images yielding processed cardiac images comprising connected image components;
labeling different connected image components yielding respective labeled connected image components; comprising:
computing, for each labeled connected image component, a factor based on a difference between a first volume of the connected image component in a first cardiac image of said cardiac images and a second volume of the connected image component in a second cardiac image of said cardiac images; and
segmenting the anatomic structure by selecting the connected image component with the factor meeting a predetermined criterion.

2. A method according to claim 1, said method further comprising a preparatory step of:
automatically computing a restrictive region of interest around the heart in the cardiac images of the multi-dimensional dataset.

3. A method according to claim 1, whereby the method further comprises the steps of:
performing a region growing operation for the multi-dimensional dataset, whereby said region growing operation is being constrained by a parameter deduced from the classified cardiac images.

4. A method according to claim 1, whereby a further anatomic structure is conceived to be segmented in the cardiac images, said method further comprising the steps of:
applying a thinning operator to the classified cardiac images yielding processed cardiac images comprising further connected image components;
labeling different further connected image components yielding respective labeled further connected image components;
computing, for each labeled further connected image component, a further factor based on a difference between a first volume of the further connected image component in a first cardiac image of said cardiac images and a second volume of the further connected image component in a second cardiac image of said cardiac images; and
segmenting the further anatomic structure by selecting the further connected image component with the value of said further factor meeting a further pre-determined criterion.

5. A method according to claim 4, further comprising the step of:
segmenting a still further anatomic structure based on a comparison between the segmented anatomic structure and the segmented further anatomic structure.

6. A method according to claim 4, further comprising the step of:
computing a still further factor based on a ratio (F1/F2) between the factor (F1) and the further factor (F2);
comparing a value of the still further factor with a still further pre-determined criterion;
performing an automatic correction of a stack of cardiac images upon an event that the still further factor and the criterion inter-relate in a pre-determined way.

7. A method according to claim 1, said method further comprising the step of:
visualizing the at least any one of the segmented anatomic structure, the segmented further anatomic structure and the segmented still further anatomic on a display means.

8. An apparatus for segmenting an anatomic structure in a multi-dimensional dataset comprising a plurality of temporally spaced cardiac images comprising data on a target matter and on an other matter, said apparatus comprising:
an input for accessing the multi-dimensional dataset;
a computing unit for:
i. performing a classification of cardiac images to distinguish between the target matter and the other matter yielding classified cardiac images comprising the target matter;
ii. applying a thinning operator to the classified cardiac images yielding processed cardiac images comprising connected image components;
iii. labeling different connected image components yielding respective labeled connected image components
iv. Computing, for each labeled connected image component, a factor based on a difference between a first volume of the connected image component in a first cardiac image of said cardiac images and a second volume of the connected image component in a second cardiac image of said cardiac; and
v. segmenting the anatomic structure by selecting the connected image component with the factor meeting a pre-determined criterion.

9. An apparatus according to claim 8, whereby the apparatus further comprises a display unit for displaying the segmented anatomic structure.

10. An apparatus according to claim 8, whereby the apparatus further comprises:
a data acquisition unit arranged to acquired the multi-dimensional dataset.

11. A working station comprising an apparatus according to claim 8.

12. A viewing station comprising an apparatus according to claim 9.

13. A computer program for segmenting an anatomic structure in a multi-dimensional dataset comprising a plurality of temporally spaced cardiac images comprising data on a target matter and on an other matter, said computer program comprising instruction to cause a processor to carry out the following steps:
performing a classification of cardiac images to distinguish between the target matter and the other matter yielding classified cardiac images comprising the target matter;
applying a thinning operator to the classified cardiac images yielding processed cardiac images comprising connected image components;
labeling different connected image components yielding respective labeled connected image components;
for each labeled connected image component compute a factor based on a difference between a first volume of the connected image component in a first cardiac image of said cardiac images and a second volume of the connected image component in a second cardiac image of said cardiac images; and
segmenting the anatomic structure by selecting the connected image component with the factor meeting a pre-determined criterion.
